(19) United States
(12) Patent Application Publication
(10) Pub. No.: US 2006/0259494 A1
(43) Pub. Date: Nov. 16, 2006

(54) System and method for simultaneous search service and email search

(75) Inventors: Eric B. Watson, Redmond, WA (US); Kenneth A. Moss, Mercer Island, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/128,397

(22) Filed: May 13, 2005

(51) Int. Cl. G06F 17/30

(52) U.S. Cl. 707/10

(57) ABSTRACT

A system and related techniques execute search queries against both remote Internet or other search services, as well as local or remote email stores. A user may access a search service Web site or other search interface, and enter search inputs or terms. That search input may be transmitted to a remote search service via the Internet or other network, as well as through access logic which communicates the same search inputs to the user's local or remote email store. Web sites as well as email messages or other content that matches the search input may be retrieved both from the remote search service as well as the email store, and presented to the user in combined or separate fashion. The access logic may manage the transmission of necessary authentication credentials to remote servers or otherwise to access and retrieve the email portion of the results. According to embodiments, email search results may be cached to improve access time and integration with results retrieved from the search service.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of computerized information retrieval, and more particularly to a system and method for executing search functions on both remote search services, such as a Web-based search index, and a user's local or remote email, simultaneously or in parallel.

### BACKGROUND OF THE INVENTION

Today's Web users frequently avail themselves of the publicly available search services to search for personal, business, academic and other information. Those services have increased in power and sophistication and may warehouse a wealth of information on those and other types of topics. Conversely, many users have come to rely upon email as a fast, inexpensive and convenient medium of communication. A significant contingent of email users may choose to store their email traffic to refer to later as a source of information on various research, transaction, personal and other topics.

However, search platforms available today fail to provide an integrated tool to access and search both a Web search site and a user's local or remote email store, in a unified fashion. A user therefore who wishes to search both Internet sources and their own personal or other email history may not be able to perform that search, or may be forced to perform two searchers, one after the other to retrieve results on the same query from those separate sources. Other problems in Web and email retrieval exist.

### SUMMARY OF THE INVENTION

The invention overcoming these and other problems in the art relates in one regard to a system and method for simultaneous remote search service and email search, in which a user may enter search input to generate results against both a Web or other networked search engine or service and one or more local or remote email stores, in a transparent and integrated operation. According to embodiments of the invention in one regard, search terms or search input may be received and managed by an access logic module, which may be hosted in the user's client or other device, for distribution to both a networked search service and email storage storing the user's email messages. The access logic may for example initiate and access the email inbox, stored folders or other email messages or data associated with the user, for example by transmitting authentication credentials to a remote email server. Search hits may be processed and retrieved from the tandem search engine and email sources, and returned to be presented to the user. According to embodiments of the invention, hits or results from both the email content and search service content may be combined for presentation to the user, for example by applying the same relevance rating to each type of content and displaying a ranked list to the user in a browser, or otherwise. In embodiments multiple local or remote email stores may be accessed, and results from those stores may in embodiments be cached to enhance further search performance.

### BRIEF DESCRIPTION OF THE DRAWINGS

FIG. 1 illustrates an overall environment in which a system and method for simultaneous remote search service and email search may operate, according to embodiments of the invention.

FIG. 2 illustrates an overall environment in which a system and method for simultaneous remote search service and email search may operate, according to embodiments of the invention in another regard.

FIG. 3 illustrates an overall environment in which a system and method for simultaneous remote search service and email search may operate, according to embodiments of the invention in a further regard.

FIG. 4 illustrates a flowchart of overall remote search and email search processing, according to embodiments of the invention.

### DETAILED DESCRIPTION OF EMBODIMENTS

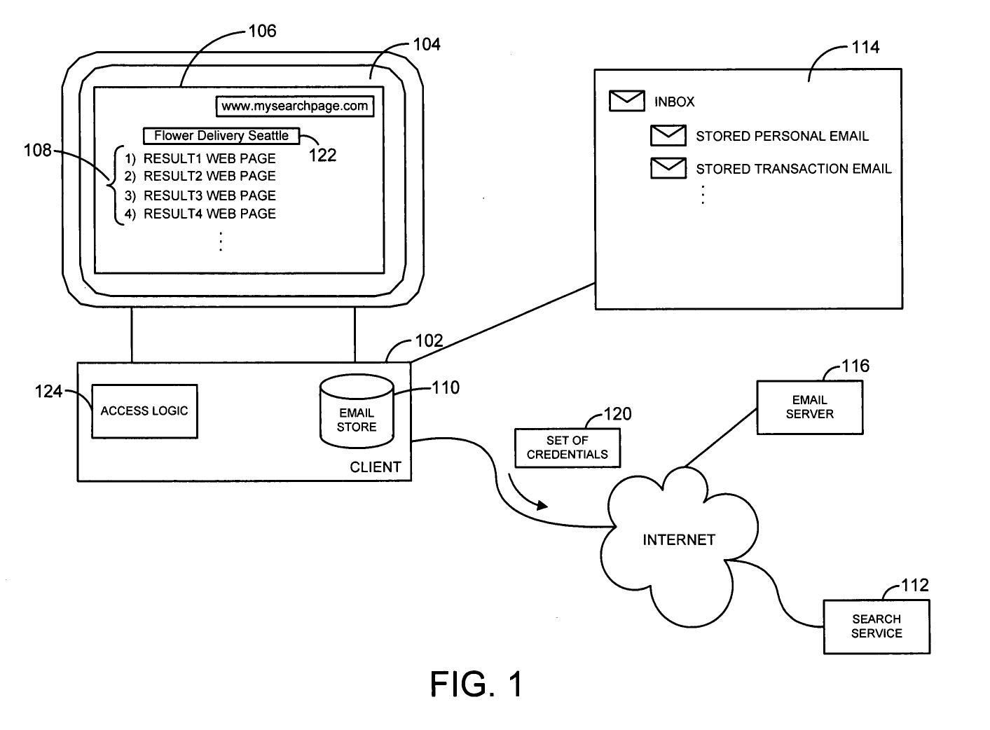

FIG. 1 illustrates an environment in which a system and method for simultaneous search service and email search may operate, according to embodiments of the invention. As illustrated in that figure, a user may operate a client 102 such as a desktop or laptop computer, a network-enabled cellular telephone, wireless email client, or other client, machine or device to perform various tasks including Web browsing, search, electronic mail (email) and other tasks, applications and functions. The user may interact with those resources via a user interface 104, such as a graphical user interface, command-line user interface, voice-recognition interface or other interface, for example to navigate to search page 106, such as an Internet or other public or private networked search page. In general the user may supply search input 122 such as typed words or other alphanumeric or other data to conduct a search via a search service 112 to receive a set of search results 108 reflecting content which contains or reflects information related to the search input 122.

In addition to accessing the search service 112 as a source of content to be searched for query matches, according to embodiments of the invention the search input 122 may also be communicated to a local or remote email store to examine stored email messages for potential matches, as well. In embodiments as illustrated, for example, the client 102 may host an email store 110, such as a set of email messages, content or documents, which may for instance be stored in “.pst” or other format. That set of email messages may be stored or presented in the form of a set of email folders 114, or other format or structure. According to embodiments of the invention in a further regard, email content may alternatively or in addition be hosted or stored in a remote email server 116, such as an Internet-based email server or store.

According to embodiments of the invention in one regard, the search input 122 received via a Web browser or other application or resource may be communicated to access logic 124, which may for example be hosted in client 102. The access logic 124 or other access engine or control may receive the search input 122 and mediate the transmission of that input to email server 116 and/or search service 112, for example to transmit a set of credentials 120 identifying and/or authenticating the user's email account with email server 116 or other email content store. For example the set of credentials 120 may contain domain name service (DNS) identifiers, point of presence (POP) identifiers, passwords, cookies, digital certificates or other security, identification or other data. Upon authentication via set of credentials 120, the email server 116 may initiate access to the user's stored email messages, content, attachment or related data. Access logic 124 may also or alternatively access the user's email store 110, which may likewise be accessed via the set of credentials 120 or otherwise to retrieve email content.

Email content retrieved from email store 110 and/or email server 116 may be transmitted to or mediated by access logic 124 to process search activity against that content using search input 122, to determine whether email content may reflect that input or content. According to embodiments of the invention in one regard, the matching of the email content to the search input 122 may be performed by access logic 124 itself, or in alternative embodiments for example be communicated to and performed by search service 112 or other local or remote resources. Hits or matches from searching against the email content may be combined with hits or matches returned from search service 112 for presentation in the set of search results 108. Those combined results may for example and as illustrated be presented in the form of a combined list of results which list Web site sources or email message sources in order of ranked relevance, in interleaved fashion.

In embodiments presenting the set of search results 108 in combined format, the access logic 124 and/or search service 112 may apply the same relevance rating engine or algorithm to list the individual results on a consistent scale and order. According to embodiments of the invention in another regard, the set of search results 108 may be further presented in other formats, such as alternate or tabbed pages for results from search service 112 versus results from email server 116/email store 110. Other output configurations and displays are possible for the set of search results 108. In embodiments of the invention in general, the user may select any one or more result from the set of results 108 to open, view or navigate to that content, whether an email source, Web site or other source or content.

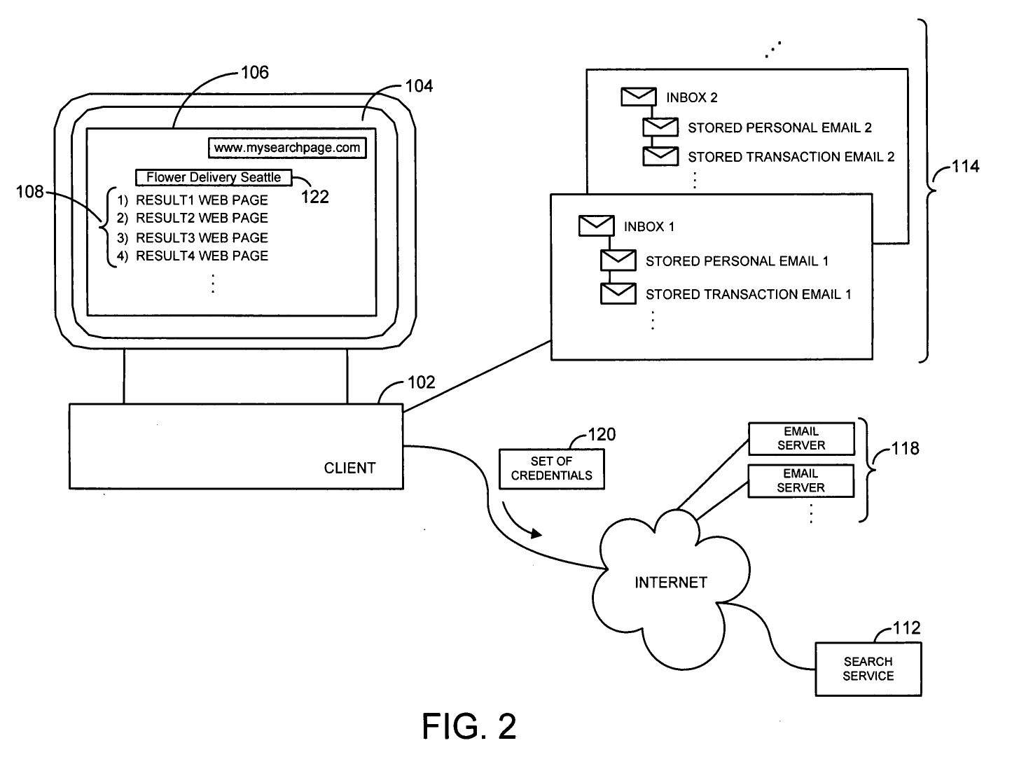

In embodiments of the invention in another regard, and as for example illustrated in FIG. 2, the access logic 124 and other search resources may access not merely one remote email store, but a set of email servers 118. Each server or email store in the set of email servers 118 may for example reflect a separate account associated with the user, or otherwise. Each of the set of email servers 118 in embodiments of this type may be accessed by the same or a separate set of credentials 120, and results from each of the sources in the set of email servers 118 may be presented in the set of email folders 114, in stacked or other format. According to embodiments of the invention as illustrated in FIG. 2, the set of search results 108 may thus contain email hits or matches combined with hits or matches from search service 112, again in interleaved or separated fashion. Other output formats are possible.

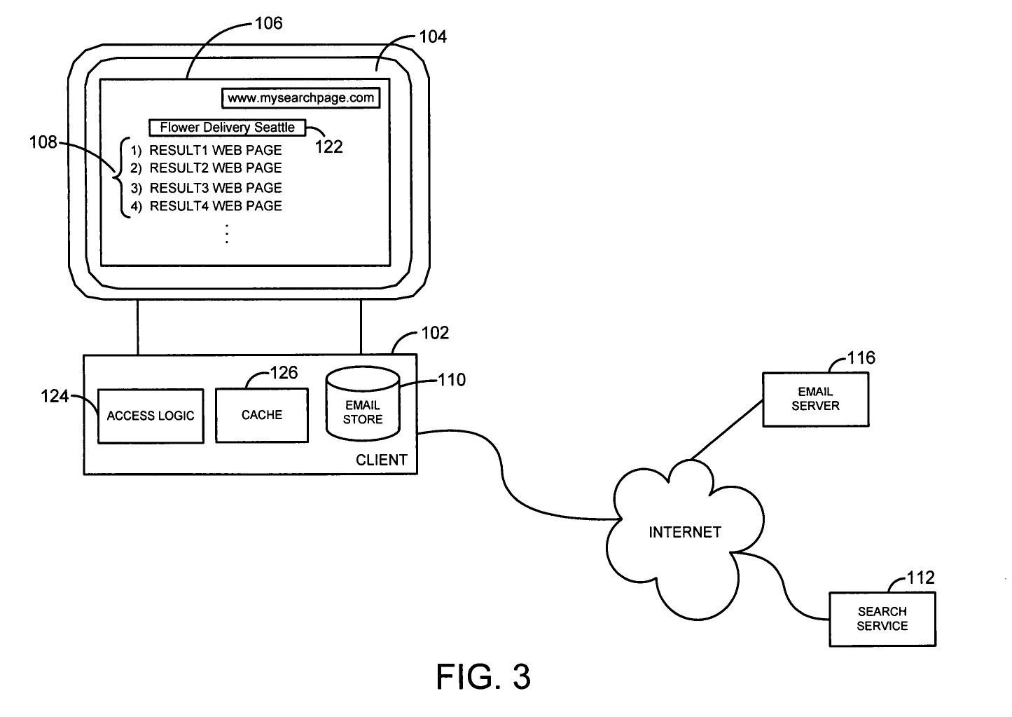

It may be noted that in embodiments of the invention, and as for example illustrated in FIG. 3, client 102 or other resource may be configured with a cache 126 for storage of email content or results, to enhance processing time integrated search service/email search. More particularly, according to implementations the transmission of the set of credentials 120 to email server 116, set of email servers 118 or other remote resources may involve some degree of round-trip transmission delay, for instance due to packet delay or other factors. When transmission delays are present, presentation of the set of search results 108 may be delayed while waiting for email access to be authenticated and secured. According to embodiments as illustrated in FIG. 3, therefore, introducing a cache 126 in client 102, and/or in other locations, may reduce any delay encountered in retrieving email hits or matches, for example by storing prior hits or matches on a per-search, per-session or other basis. Other storage enhancements are possible.

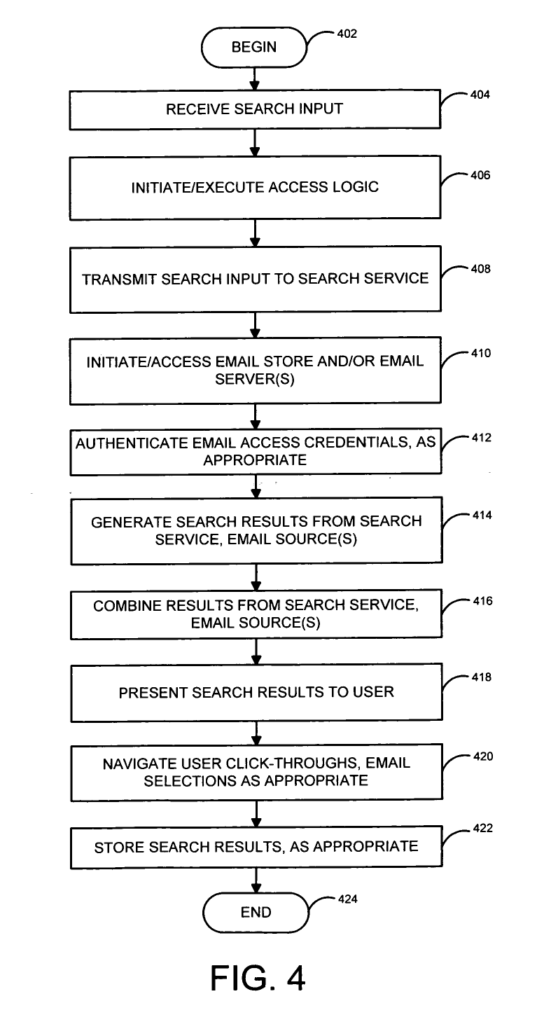

Overall processing for integrated search processing on remote search service and email sources is illustrated in FIG. 4. In step 402, processing may begin. In step 404, search input 122 may be received, for example by way of a user typing in search words, characters or other data in a dialogue box on a Web page, or otherwise. In step 406, access logic 124 may be initiated or accessed, for instance via the user's Web browser, operating system or other module or resource. In step 408, the search input 122 may be transmitted to a search service 112, such as a publicly available search engine hosted on the Internet, or other public or private search engines or services. In step 410, the access logic 124 may initiate processing on or access the user's email store 110 or other local or remote email storage or location, such as for example email server 116 or other email content stores. In step 412, the email store 110, the email server 116 or other local or remote resources may authenticate the set of credentials 120 associated with the user, such as a cookie, digital certificate, or other credential or data.

In step 414, search results based on the search input 122 may be generated by the search service 112 as well as the email store 110, email server 116 or other local or remote email content store. In step 416, search results from the search service 112, email store 110, email server 116 or other local or remote sources may be combined into a set of search results 108. In step 418, the set of search results 108 may be presented to the user, for instance in a combined listing via search page 106 displaying results from both search service 112 and email store 110 and/or email server 116, in interleaved fashion based on a unified ranking of relevance of hits from those diverse sources. According to embodiments of the invention in another regard, the set of search results 108 may be presented in a separate set of listings via search page 106, for example in a tabbed or otherwise selectable format to view results from search service 112 and results from email store 110/email server 116 separately. Other display configurations are possible.

In step 420, user click-throughs or other selections in the set of search results 108 may be navigated, for example to view an email message or Web site. In step 422, the set of search results 108 may be stored or cached, as appropriate. In step 424, processing may repeat, return to a prior processing point, jump to a further processing point or end.

The foregoing description of the invention is illustrative, and modifications in configuration and implementation will occur to persons skilled in the art. For instance, while the invention has generally been described in terms of results returned from a single search service 112 along with one or more email stores, in embodiments search operations may be carried out via two or more search services or engines, along with email retrieval from single or multiple stores.

Similarly, while the invention has in embodiments been described as involving access logic 124 which may be hosted in client 102, in embodiments some or all of the access logic may be hosted in search service 112, in email server 116, in multiple search engines or services, multiple email servers or stores, or distributed in other local or remote resources. Other hardware, software or other resources described as singular may in embodiments be distributed, and similarly in embodiments resources described as distributed may be combined. The scope of the invention is accordingly intended to be limited only by the following claims.

What is claimed:

1. A system for generating search results, comprising:
an input interface to receive search input; and
an access engine, the engine communicating with the input interface to receive the search input and manage the distribution of the search input to at least one email store and at least one search service, and manage the presentation of a set of search results received from the at least one email store and at least one search service.

2. A system according to claim 1, wherein the at least one email store comprises at least one local email store hosted in a client.

3. A system according to claim 1, wherein the at least one email store comprises at least one remote networked email store.

4. A system according to claim 1, wherein the at least one email store comprises a plurality of email stores.

5. A system according to claim 1, wherein the search service comprises at least one of a public Internet search service and a private network search service.

6. A system according to claim 1, wherein the presentation of the set of search results comprises a ranked list of matches in a interleaved fashion based on a unified ranking of relevance from the at least one email store and the at least one search service.

7. A system according to claim 1, wherein the access engine accesses a cache to return matches associated with the at least one email store.

8. A method for generating search results, comprising:
receiving search input; and
managing the distribution of the search input to at least one email store and at least one search service; and
managing the presentation of a set of search results received from the at least one email store and at least one search service.

9. A method according to claim 8, wherein the at least one email store comprises at least one local email store hosted in a client.

10. A method according to claim 8, wherein the at least one email store comprises at least one remote networked email store.

11. A method according to claim 8, wherein the at least one email store comprises a plurality of email stores.

12. A method according to claim 8, wherein the search service comprises at least one of a public Internet search service and a private network search service.

13. A method according to claim 8, wherein the managing the presentation of the set of search results comprises generating a ranked list of matches from the at least one email store and the at least one search service.

14. A method according to claim 8, further comprising processing a set of credentials to authenticate access to the at least one email store.

15. A set of search results, the set of search results being generated by a method comprising:
receiving search input; and
managing the distribution of the search input to at least one email store and at least one search service; and
managing the presentation of a set of search results received from the at least one email store and at least one search service.

16. A set of search results according to claim 8, wherein the at least one email store comprises at least one local email store hosted in a client.

17. A set of search results according to claim 8, wherein the at least one email store comprises at least one remote networked email store.

18. A set of search results according to claim 8, wherein the at least one email store comprises a plurality of email stores.

19. A set of search results according to claim 8, wherein the search service comprises at least one of a public Internet search service and a private network search service.

20. A set of search results according to claim 8, wherein the managing the presentation of the set of search results comprises generating a ranked list of matches from the at least one email store and the at least one search service.
